(19) United States
(12) Patent Application Publication
(10) Pub. No.: US 2004/0023798 A1
(43) Pub. Date: Feb. 5, 2004

(54) Micro-structured, self-cleaning catalytically active surface

(76) Inventors: Gerd Kaibel, Lampertheim (DE); Thomas Domschke, Speyer (DE); Mathias Haake, Mannheim (DE); Harald Keller, Ludwigshafen (DE); Ekkehard Schwab, Neustadt (DE); Carsten Oost, Durkheim (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/398,394

(22) PCT Filed: Sep. 28, 2001
(86) PCT No.: PCT/EP01/11284

(30) Foreign Application Priority Data
Oct. 5, 2000 (DE) 10049338.6

(51) Int. Cl. B01J 23/40

(52) U.S. Cl. 502/325

(57) ABSTRACT

The invention provides a microstructured, self-cleaning, catalytically active surface with elevations and depressions, comprising a catalytically active material in the depressions.

The invention additionally provides a process for producing a microstructured, self-cleaning, catalytically active surface and a catalyst molding having such a surface in which a support surface is powder coated with particles having a size of from 0.05 to 200 μm and is subsequently coated with a catalytically active material.

In a preferred embodiment of the process,

(a) if desired, a base layer of metal is applied to a support surface by layer deposition from solution,

(b) on the support surface or, if appropriate, on the surface of the base layer, a first layer of metal containing embedded particles with a size of from 0.05 to 200 μm is applied by layer deposition from a solution containing these particles in dispersed form, and

(c) the first layer is coated with a catalytically active second layer.

The invention relates to microstructured, self-cleaning catalytically active surfaces, to catalyst moldings comprising such surfaces, to processes for preparing the surfaces and catalyst moldings, and to the use thereof.

Heterogeneously catalyzed processes conducted in the liquid phase often suffer because the starting material stream to be reacted includes components which occupy the surface of the catalyst and so lead to its deactivation. To date it has been attempted to solve this problem by looking for alternative active components less sensitive to poisoning or else inserting in an absorber layer upstream of the catalyst bed. In certain cases, mechanical separation of interfering particles by filtration upstream of the catalysis reactor has been used to solve the problem. Disadvantages of these methods are that the absorber layer has to be regenerated at regular intervals and that filtration is burdensome.

It is an object of the invention to provide alternatives to the known solutions. A particular object of the invention is to provide heterogeneous catalysts with which heterogeneously catalyzed processes can be conducted in the liquid phase without the need for solid, colloidal or dissolved, catalyst-deactivating particles to be separated from the starting material stream beforehand.

We have found that this object is achieved by means of a microstructured, self-cleaning, catalytically active surface with elevations and depressions, said surface comprising catalytically active material in the depressions.

The catalytically active, self-cleaning surface may be microstructured as described in WO 96/04123. The surface described therein has elevations and depressions, the distance between the elevations being from 5 to 200 μm, preferably from 10 to 100 μm, the height of the elevations being from 5 to 100 μm, preferably from 10 to 50 μm, and at least the elevations being of a hydrophobic material. The water repellency of these surfaces is attributed to the fact that the water drops lie only on the peaks of the elevations and thus have only a small area of contact with the surface. The water drop, occupying the smallest possible surface area, forms a bead and rolls off from the surface at the slightest vibration. Similarly, the adhesion of solid particles to the surface is reduced. These particles have a more or less great affinity for water, so that they are removed from the surface together with the drops which roll off.

A microstructured, self-cleaning, catalytically active surface in accordance with one embodiment of the invention may be described as follows.

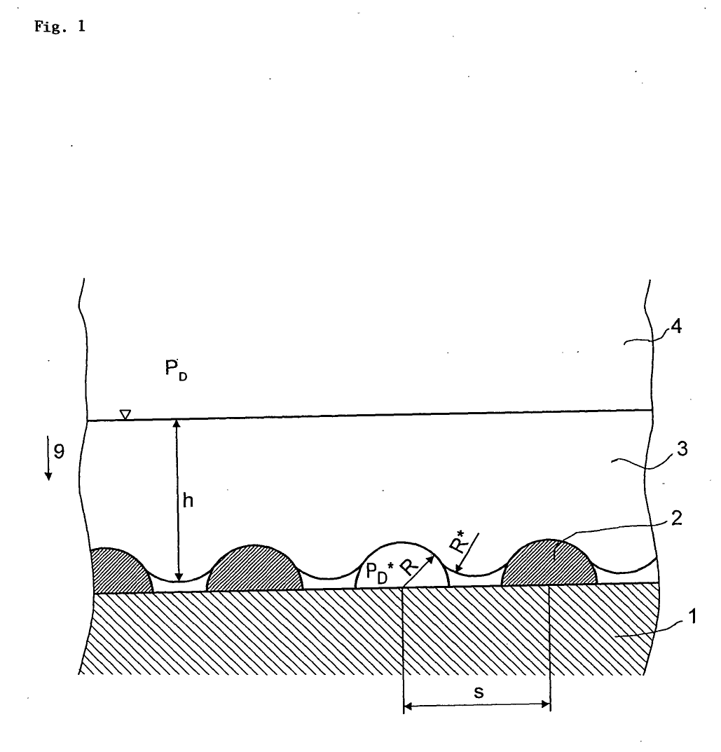

FIG. 1 shows an idealized representation of a section through a self-cleaning microstructured surface in accordance with one embodiment of the invention. The idealized microstructured heat exchange surface (1) has hemispherical elevations (2) of radius R, arranged with a spacing s, and depressions in-between. The distance s between the elevations (2) is such that a liquid (3) hanging down between the elevations occupies a radius of curvature R*, and in the depressions between the elevations (2) does not contact the heat exchange surface (1). Preferably s<4R. In the vapor space (4), the vapor pressure pᵥ of the liquid (3) at the system temperature is established; in the case of ideal mixtures, the sum of the vapor pressures of the components. The downward-hanging curve of the liquid is subject to the sum of this vapor pressure pᵥ plus the hydrostatic pressure p_{hy}, i.e., in the case of a horizontal heat exchange surface:

pᵥ+ρ_{liq}gh.

It is known that the vapor pressure over curved phase boundaries is greater than over planar phase boundaries. The vapor pressure over a curved surface is

pᵥ(R*)=pᵥ exp(2σ_{AB}V_{liq}/(R* [symbol] T),

where

pᵥ(R*) is the vapor pressure over the phase boundary with the radius of curvature R*,

pᵥ is the vapor pressure over the planar phase boundary,

σ_{AB} is the surface tension between the liquid phase and the solid phase of the elevation (2),

V_{liq} is the molar volume of the liquid phase,

R* is the radius of curvature of the downward-hanging liquid,

[symbol] is the ideal gas constant, and

T is the temperature.

The structure of the surface is then such that R* becomes so small that at the anticipated film thicknesses h the vapor pressure pᵥ(R*) always remains at least equal to the sum of pᵥ+p_{hy}. In that case, the liquid (3) is unable to wet the surface.

The nonwettability of the catalytically active surface can therefore be attributed to the vapor pressure increase in small drops. For a heterogeneously catalyzed reaction conducted in the liquid phase, transport of the reactant molecules to and from the catalyst surface, owing to the nonwettability of that surface, can take place only by way of the gas phase. Catalyst poisons which possess a lower vapor pressure than the substances to be reacted therefore reach the catalyst surface only to a greatly reduced extent, if at all, and are consequently unable to poison the catalyst. The result is a catalyst which is intrinsically insensitive to the poisons contained in the starting material stream and product stream. As a result, the catalyst may be operated for long periods without the need for burdensome prepurification of the starting material stream.

If, however, solids are deposited on the catalytically active surfaces of the invention, they are easy to remove mechanically, for example, by simple flushing or by blowing with compressed air.

Depending on the way in which they are produced, real microstructured surfaces will generally have a geometry which deviates to a greater or lesser extent from the idealized geometry indicated in FIG. 1. In particular, the elevations (2) will not be exactly hemispherical and their radius R and distance s will vary to a greater or lesser extent. Moreover, the depressions lying between the elevations (2) need not be planar. Preferably, however, the elevations will have an essentially rounded form and will have on average a radius R of from 5 to 100 μm and a distance s of from 5 to 200 μm.

The microstructured, self-cleaning, catalytically active surface of the invention comprises a catalytically active material in the depressions. The presence of catalytically active material on the elevations of the surface as well does no harm. In the worst-case scenario, this material which is present on the elevations will, in time, become inactive as a result of poisoning. In contrast, the active material present in the depressions is protected against poisoning by the mechanism described above, so that the surface as a whole remains catalytically active.

In general, the elevations of the microstructured surface will have a polarity opposite to the polarity of the starting material stream to be reacted, this polarity ensuring the nonwettability of the catalytically active surface. In the case of aqueous, aqueous-organic or polar starting material streams, the elevations will have hydrophobic properties. In contrast, in the case of nonpolar substances, the elevations will have hydrophilic properties. The whole microstructured surface may have a polarity opposite to the polarity of the liquid starting material phase.

In principle, any catalytically active material is suitable. In one embodiment of the invention, the catalytically active surface comprises a catalytically active metal. In one preferred embodiment of the invention, the catalytically active metal in the catalytically active surface is an element from groups 8 to 11 of the Periodic Table or an alloy of these elements. These metals catalyze, for example, hydrogenations, suitable alloys comprising in particular those of elements from groups 8 to 10 with, preferably, copper, silver and gold and also chromium, zinc, cadmium, lead or bismuth.

In one embodiment of the invention, the catalytically active surface comprises palladium as catalytically active metal.

The microstructured, self-cleaning, catalytically active surface may be present on an inert support, which may be a metal foil or a metal sheet, for example. The microstructured, self-cleaning, catalytically active surface may be the surface of a catalyst molding. This molding may have been prepared, for example, by shaping a suitable deformable inert support comprising the catalytically active surface.

The microstructured surface may be produced by powder coating of adhesives and coating materials applied to the support. This can be done by, for example, blowing or powdering hydrophobic pigments, Teflon powders, wax powders, polyethylene or polypropylene powders, hydrophobicized SiO₂ or similar particulate substances of appropriate particle size onto the support surface which has been wetted with the coating material or adhesive. Suitable hydrophilic powders are, for example, powders of nonhydrophobicized SiO₂. The size of the powder particles is generally in the range from 0.05 to 200 μm. The powders preferably have a narrow particle size distribution. It is also possible to use powders having a bimodal particle size distribution. Such powders may, for example, comprise particles of a first size class having an average particle diameter in the range from 1 to 50 μm, alongside particles of a second size class having a particle diameter in the range from 0.05 to 1.2 μm. With these powders, catalyst surfaces having a fractal (self-similar) surface structure are obtained; that is, the microstructure of the surface is also nanostructured in the same way. In this way it is possible to very good effect to mimic the microstructured and nanostructured surfaces which are encountered in nature. The microstructured surfaces may also be obtained by layer deposition from solutions, such as electrolytic or galvanic deposition, etching techniques, or vapor deposition. Subsequently, the microstructured surfaces obtained may be coated with a catalytically active material.

In one process for preparing the microstructured, self-cleaning, catalytically active surface or the catalyst molding having said surface, a support surface is powder coated with particles having a size of from 0.05 to 200 μm and is then coated with a catalytically active material. Suitable coating techniques for coating the microstructured surface with a catalytically active material are all customary coating techniques. Preference is given to techniques wherein coating takes place from an aqueous solution or dispersion of the active component. Particularly preferred techniques are those in which the active component is deposited from the gas phase by chemical or physical vapor deposition. It is not critical if the elevations applied to the support surface are also coated.

In a further preferred process for preparing a microstructured, self-cleaning catalytically active surface and a catalyst having such a surface,

a) if desired, a base layer of metal is applied to a support surface by layer deposition from solution,

b) on the support surface or, if appropriate, on the surface of the base layer, a first layer of metal containing embedded particles with a size of from 0.05 to 200 μm is applied by layer deposition from a solution containing these particles in dispersed form, and

c) the first layer is coated with a catalytically active second layer.

The layer deposition from solution may take place galvanically or electrolytically from a corresponding metal salt solution onto the support surface. The support surface is generally a metal foil or a metal sheet, made of stainless steel, for example. The base layer may consist, for example, of nickel. Suitable galvanic baths are known to the skilled worker and are described, for example, in Ullmanns Encyclopaidie der Technischen Chemie, 6th edition 1999, chapter on “Electrochemical and Chemical Deposition”. As likewise described therein, the base layer may also be applied electrolytically.

A first layer of metal containing embedded particles having a size of from 0.05 to 200 μm is applied to the surface of the base layer or else directly to the support surface. Suitable particles are all of the abovementioned particles, and are chosen as a function of the properties of the starting material stream to be reacted. Preferred particles having hydrophobic properties are made of polytetrafluoroethene. The first layer is applied by layer deposition from a solution containing these particles in dispersed form, layer deposition taking place galvanically or electrolytically. It is possible to use the galvanic baths or electrolysis baths used to produce the base layer, said baths further comprising the particulate substance in dispersed form, preferably in amounts of from 0.1 to 10% by weight.

In one preferred embodiment of the invention, a metal base layer and/or a metal-polymer dispersion first layer are/is deposited electrolessly (galvanically) by contacting the surface to be coated with a metal electrolyte solution comprising not only the metal electrolyte but also a reducing agent and, if desired, the polymer or polymer mixture to be deposited. The metal layer preferably comprises an alloy or alloylike mixed phase of a metal and at least one further element. The metal-polymer dispersion phases comprise a polymer, preferably a halogenated polymer and, optionally, further polymers, which is dispersed in the metal layer. The metal alloy is preferably a metal boron alloy or a metal phosphorus alloy having a boron or phosphorus content, respectively, of from 0.5 to 15% by weight. With particular preference, the alloy comprises a nickel alloy having a phosphorus content of from 0.5 to 15% by weight. Metal electrolyte solutions used are commercially customary metal electrolyte solutions comprising, in addition to the electrolyte, a reducing agent such as alkali metal hypophosphite or boranate, a buffer mixture, an activator if desired, such as NaF, KF or LiF, carboxylic acids, and, optionally, a deposition moderator such as Pb²⁺. The halogenated polymer is preferably polytetrafluoroethene (PTFE), which may be used as a commercially customary PTFE dispersion in an aqueous surfactant solution. Preference is given to using PTFE dispersions having a solids content of from 35 to 60% by weight and an average particle diameter in the range from 0.05 to 1.2, in particular from 0.1 to 0.3 μm. Particular preference is given to spherical particles, which lead to highly homogeneous composite layers. General operating conditions for the coating operation are temperatures from 40 to 95° C., preferably from 80 to 91° C., deposition rates of from 1 to 15 μm/h, electrolyte concentrations of, for example, from 1 to 20 g/l Ni²⁺ or from 1 to 50 g/l Cu²⁺, and a pH of from 3 to 6, preferably from 4 to 5.5. The thickness of the deposited composite layer is generally from 1 to 100 μm, preferably from 3 to 50 μm, with particular preference from 5 to 25 μm, its polymer content generally from 5 to 30% by volume, preferably from 15 to 25% by volume.

In a further preferred embodiment of the invention, the metal-polymer dispersion layer includes a further polymer as well as a halogenated first polymer, by means of which further polymer the antiadhesion properties of the coating are further intensified. This polymer may be halogenated or nonhalogenated. The further polymer preferably comprises ethylene homopolymers or copolymers or polypropylene, in which case ultrahigh molecular mass polyethylene (UHM-PE, M_{W}>10⁶) is particularly preferred. This optional further polymer may likewise be added to the electrolyte solution as a commercially customary dispersion in an aqueous surfactant solution. Important for this embodiment is that the particles of the further polymer are coarser than those of the halogenated first polymer. For instance, average particle diameters of from 5 to 50 μm are advantageous. From 25 to 35 μm are particularly advantageous. It is especially important that the particle diameter distribution of the polymer mixture comprising first and further polymer is bimodal overall.

Prior to the application of the metal-polymer dispersion first layer, a base layer of from 1 to 15 μm, preferably 1˜5 μm in thickness is preferably applied by electroless chemical deposition.

The first layer formed in this way is coated with a catalytically active second layer, in which case all of the abovementioned coating techniques may be employed. Coating with the catalytically active second layer preferably takes place by physical vapor deposition. The thickness of the catalytically active layer is generally from 1 to 500 nm, preferably from 10 to 100 nm.

The support coated by one of the processes described above, preferably a metal foil, may subsequently be shaped to form a catalyst molding. The support may also be shaped first and then coated. Suitable moldings may be produced, for example, by rolling the coated support foil.

The reactors used to conduct the heterogeneously catalyzed reaction comprise all embodiments in which it is possible to install a fixed catalyst bed. Heterogeneously catalyzed reactions in which the catalytic surfaces and the catalysts of the invention may be employed with advantage are all heterogeneously catalyzed liquid-phase reactions, thus including those which are carried out in two phases, solid/liquid, and those carried out in three phases, solid/liquid/gaseous, it being possible in the latter case for the gas phase to comprise one of the reactants.

In one preferred embodiment of the invention, the catalytically active surface or the catalyst of the invention is used in heterogeneously catalyzed processes for hydrogenating unsaturated organic compounds in the liquid phase. In this context, hydrogenations in polar media, examples being aqueous or aqueous-organic solutions of the substances to be hydrogenated, are generally carried out over catalytically active surfaces comprising hydrophobic particles, and hydrogenations in nonpolar media are generally carried out over catalytically active surfaces comprising hydrophilic particles. Examples are the hydrogenation of ethylenically or acetylenically unsaturated compounds, such as that of dehydrolinalool to hydrolinalool, or of industrial crude butynediol obtained by the Reppe process to butenediol and/or butanediol, or else the hydrogenation of (nonpolar) raffinate mixtures.

The catalyst of the invention is especially suitable for hydrogenation processes in which reactant solutions frequently contaminated with dissolved, colloidal or solid substances that act as catalyst poisons are used.

The invention is illustrated by the examples below.

### EXAMPLES

Preparation of a Microstructured Catalyst Support Surface

### Example 1

A metal foil made of Kanthal (material No. 1.4767) is coated with a composite comprising polyisobutene coating material and hydrophobicized silicate powder with an average particle size of 50 μm (Aerosil 812S from Degussa). The coating is subsequently cured by UV irradiation.

To demonstrate the self-cleaning function of the surface thus prepared, a determination is carried out of the angle of inclination at which a drop of a 50% strength by weight solution of butynediol in water rolls off when applied to the metal. The same experiment is carried out with a metal sheet coated with Teflon powder. In the case of the coated metal sheet, the angle of inclination is 1°, in the case of the uncoated metal sheet it is 20°.

### Example 2

A stainless steel foil (material No. 1.4301) is heated at 900° C. in air for 5 hours. After cooling, the material is galvanically surface-modified. First of all, the metal foil is provided with a nickel base layer approximately 9 μm in thickness in a galvanic bath containing 27 g/l NiSO₄•6H₂O, 21 g/l NaH₂PO₂•2H₂O, 20 g/l lactic acid, 3 g/l propionic acid, 5 g/l sodium citrate and 1 g/l sodium fluoride at 88° C. and a pH of 4.8. Subsequently, in a galvanic bath of identical composition but with the further addition of 1% by volume of a 50% by weight PTFE dispersion having a particle size of from 0.1 to 0.3 μm and 7 g/l ultrahigh molecular mass polyethylene (UHM-PE) having a particle size of from 25 to 35 μm, a further layer, approximately 15 μm in thickness, is applied to said base layer.

Coating the Microstructured Surface with Catalytically Active Material

### Example 3

The metal foil with its surface microstructured in accordance with Example 1 is coated under reduced pressure at 10⁻⁶ mbar with 100 Å of Pd. This gives catalyst 1a.

### Example 4

The metal foil with its surface microstructured in accordance with Example 1 is coated under reduced pressure at 10⁻⁶ mbar with 60 Å of Pd. This gives catalyst 1b.

### Example 5

The metal foil with its surface microstructured in accordance with Example 1 is coated under reduced pressure at 10⁻⁶ mbar with 50 Å of Pd. This gives catalyst 1c.

Demonstration of the Catalytic Activity

### Example 6

Catalyst 1a is installed as a monolithic packing with a volume of 150 ml into a tubular reactor. The volume of the test apparatus filled with starting material is 500 ml. The hydrodehydrolinalool is hydrogenated to hydrolinalool at 80° C. and 1.1 bar hydrogen pressure. 30% of the starting material used was reacted within 4 hours.

A SEM micrograph of the catalyst surface is prepared before and after hydrogenation. As shown by these micrographs, the catalyst following hydrogenation is flawless, i.e. the microstructured surface has not changed under the conditions of the catalysis.

### Example 7

As in Example 6, catalyst 1b is installed as a monolithic packing into a tubular reactor. A 50% strength by weight aqueous solution of pure butynediol is hydrogenated at 90° C. and 2 bar hydrogen partial pressure. After 5 hours, the conversion to butenediol if 19.1%.

As SEM micrographs show, the catalyst after hydrogenation is flawless, i.e., the microstructured surface has not changed under the conditions of catalysis.

Demonstration of the Improved Poisoning Resistance

### Example 8

Catalyst 1c is installed in a tubular reactor. Industrial butynediol—i.e., butynediol contaminated in particular with high molecular mass SiO₂ colloids—is hydrogenated at 90° C. and 2 bar hydrogen partial pressure. After 6 hours, the conversion to butenediol is 8%. Following the hydrogenation, the dark brown product solution is run off and the catalyst is cleaned with methanol. As SEM micrographs show, the catalyst after hydrogenation is mechanically flawless, i.e., the microstructured surface has not changed under the conditions of the catalysis. Using the cleaned catalyst, butynediol is again hydrogenated as described above. After 5 hours, the conversion to butenediol is 1.22%.

### Comparative Example 1

A layer of palladium 5 nm thick was applied by vapor deposition directly to a sheet of the material No. 1.4767, pretreated as in Example 1, without the application of a microstructured coating beforehand. The resulting catalyst is subjected to a catalytic test with pure butynediol as in Example 7. After 7 hours, the conversion to butenediol is 30%. Following hydrogenation, the dark brown product solution is run off and the catalyst is cleaned with methanol. Using the cleaned catalyst, butynediol is hydrogenated again as described above. After 8 h, no butenediol was detectable.

We claim:

1. A process for producing a microstructured, self-cleaning, catalytically active surface, in which a support surface is powder coated with particles having a size of from 0.05 to 200 μm and is subsequently coated with a catalytically active material.

2. The process of claim 1, characterized in that the catalytically active metal is selected from groups 8 to 11 of the Periodic Table of the elements, or alloys of these elements.

3. The process for preparing a catalyst molding, wherein the surface of a deformable inert support as claimed in claim 1 or 2 ist coated and the coated support is shaped into a catalyst molding.

4. A microstructured, self-cleaning, catalytically active surface and a catalyst molding, obtainable by a process as claimed in any of claims 1 to 3.

5. A process for preparing a microstructured, self-cleaning, catalytically active surface, in which
(a) optionally, a base layer of metal is applied to a support surface by layer deposition from solution,
(b) on the support surface or, if appropriate, on the surface of the base layer, a first layer of metal containing embedded particles with a size of from 0.05 to 200 μm is applied by layer deposition from a solution containing these particles in dispersed form, and
(c) the first layer is coated with a catalytically active second layer.

6. The process as claimed in claim 5, characterized in that the catalytically active metal is selected from groups 8 to 11 of the Periodic Table of the elements, or alloys of these elements.

7. The process as claimed in claim 5 or 6, having one or more of the following features:
the layer deposition takes place galvanically or electrolytically;
the support surface is the surface of a metal foil;
the particles are made of polytetrafluoroethene;
the coating with the catalytically active second layer takes place by vapor deposition.

8. The process as claimed in any of claims 5 to 7, in which the surface of a metal foil or metal sheet is coated and subsequently shaped into a catalyst molding.

9. A microstructured, self-cleaning, catalytically active surface and catalyst molding preparable by a process as claimed in any of claims 5 to 8.

10. The use of a self-cleaning, microstructured, catalytically active surface and catalyst as defined in claim 4 or 8 for hydrogenating unsaturated organic compounds.

11. The use as claimed in claim 10 for hydrogenating unsaturated organic compounds in the liquid phase.
